(19) United States
(12) Patent Application Publication
(10) Pub. No.: US 2020/0298484 A1
(43) Pub. Date: Sep. 24, 2020

(54) MOLDING APPARATUS

(71) Applicant: FUJI XEROX CO., LTD., Tokyo (JP)

(72) Inventor: Kentaro AGEISHI, Kanagawa (JP)

(73) Assignee: FUJI XEROX CO., LTD., Tokyo (JP)

(21) Appl. No.: 16/551,731

(22) Filed: Aug. 27, 2019

(30) Foreign Application Priority Data
Mar. 22, 2019 (JP) 2019-055054

(51) Int. Cl. B29C 64/241; B29C 64/106; B29C 64/205

(52) U.S. Cl. CPC B29C 64/241; B33Y 30/00; B29C 64/205; B29C 64/106

(57) ABSTRACT

A molding apparatus includes: a receiving part on which a wire-shaped molding material that is formed of a bundle of continuous fibers impregnated with resin is discharged; a discharge part that discharges the molding material on the receiving part; and a rotation mechanism that rotates the discharge part to spirally twist the molding material being discharged from the discharge part.

### CROSS-REFERENCE TO RELATED APPLICATIONS

This application is based on and claims priority under 35 USC 119 from Japanese Patent Application No. 2019-055054 filed Mar. 22, 2019.

### BACKGROUND

### (i) Technical Field

The present disclosure relates to a molding apparatus.

### (ii) Related Art

International Publication No. 2018/151074 discloses a three-dimensional printing apparatus capable of continuously discharging a filament wire, which is formed of a fiber bundle impregnated with resin. The three-dimensional printing apparatus includes a twisting part capable of changing the degree of twisting of the overall filaments or the degree of twisting of the fiber bundle.

### SUMMARY

In the configuration in which an article is molded from a molding material that is formed of a bundle of continuous fibers spirally twisted and impregnated with resin, the strength of the molding material may decrease.

Aspects of non-limiting embodiments of the present disclosure relate to suppressing decrease in strength of the molding material, compared with that in the configuration in which a bundle of continuous fibers are spirally twisted and impregnated with resin.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a molding apparatus including: a receiving part on which a wire-shaped molding material that is formed of a bundle of continuous fibers impregnated with resin is discharged; a discharge part that discharges the molding material on the receiving part; and a rotation mechanism that rotates the discharge part to spirally twist the molding material being discharged from the discharge part.

### BRIEF DESCRIPTION OF THE DRAWINGS

Exemplary embodiment of the present disclosure will be described in detail based on the following figures, wherein:

FIG. 1 schematically shows the configuration of a molding apparatus according to an exemplary embodiment;

FIG. 2 is a sectional view of a bundle of continuous fibers used in the molding apparatus according to this exemplary embodiment;

FIG. 3 is a sectional view of a molding material used in the molding apparatus according to this exemplary embodiment;

FIG. 4 is a sectional view of the molding material shown in FIG. 3 in a flattened state;

FIG. 5 is a block diagram showing the configuration of a controller of the molding apparatus according to this exemplary embodiment;

FIG. 6 shows a portion of an article molded by the molding apparatus according to this exemplary embodiment; and

FIG. 7 schematically shows the operation of a discharge part according to this exemplary embodiment.

### DETAILED DESCRIPTION

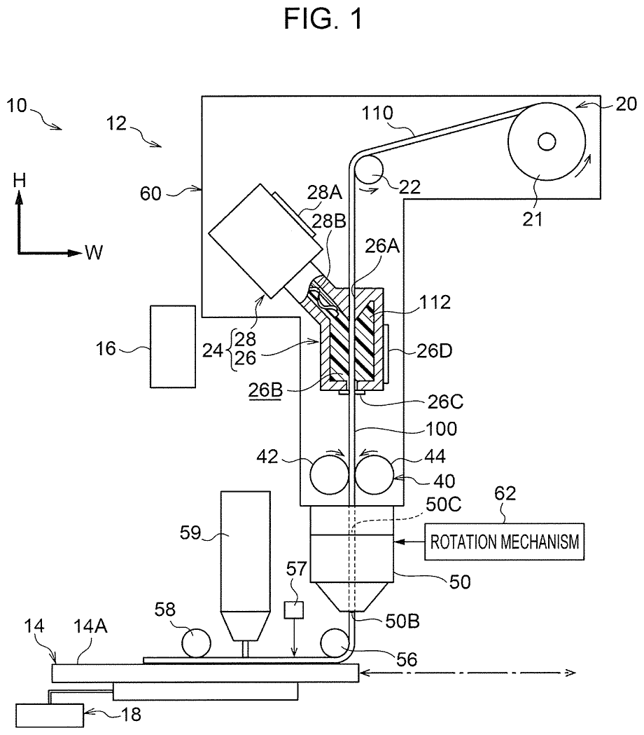

An exemplary embodiment of the present disclosure will be described below with reference to the drawings. In FIG. 1, arrow H indicates the height direction of the molding apparatus (vertical direction), and arrow W indicates the width direction of the molding apparatus (horizontal direction). The direction intersecting (more specifically, perpendicular to) the height and the width directions of the molding apparatus is the depth direction of the molding apparatus (horizontal direction).

### Molding Apparatus

First, a molding apparatus 10 will be described. FIG. 1 schematically shows the configuration of the molding apparatus 10.

The molding apparatus 10 shown in FIG. 1 is an apparatus for molding an article. More specifically, the molding apparatus 10 is a three-dimensional molding apparatus (a so-called 3D printer) employing a so-called fused deposition modeling (FDM) method. The molding apparatus 10 molds an article by forming multiple layers with a molding material 100 according to layer data about the layers.

As shown in FIG. 1, the molding apparatus 10 according to this exemplary embodiment includes: a molding unit 12; a stage 14; a moving mechanism 18; and a control unit 16. A molding material 100 (see FIG. 3) used in the molding apparatus 10 is a wire-shaped molding material that is formed of a bundle 110 of continuous fibers 120 (hereinbelow, a fiber bundle 110) impregnated with resin 112. The “wire shape” is a shape having a certain length in one direction, and the sectional shape of the molding material 100 is not specifically limited. Hence, the molding material 100 may have any sectional shape, such as a circular, flat, rectangular, triangular, or square sectional shape.

### Stage and Moving Mechanism

The stage 14 shown in FIG. 1 is an example receiving part. The molding material 100 is discharged on the stage 14. More specifically, the molding material 100 discharged on the stage 14 is placed on the stage 14. An article is molded by the molding material 100 on the stage 14. The stage 14 may be preheated.

As shown in FIG. 1, the stage 14 is disposed below the molding unit 12. The stage 14 includes a receiving surface 14A, on which the molding material 100 is discharged (in other words, on which the molding material 100 is placed). The receiving surface 14A is facing the molding unit 12, that is, the stage 14 is facing up. The receiving surface 14A is a horizontal surface.

The moving mechanism 18 shown in FIG. 1 moves the stage 14. The moving mechanism 18 moves the stage 14 linearly in, for example, the width or depth direction of the molding apparatus. In other words, the moving mechanism 18 moves the discharge part 50 relative to the stage 14 linearly in the width or depth direction of the molding apparatus.

The moving mechanism 18 can move the stage 14 to a desired position in the width and the depth directions of the molding apparatus. Hence, the moving mechanism 18 can move the discharge part 50 relative to the stage 14 linearly in a direction at an angle to the width and the depth directions of the molding apparatus.

The moving mechanism 18 can also move the discharge part 50 relative to the stage 14 in a curve. The moving mechanism 18 can move the discharge part 50 relative to the stage 14 in a curve in the clockwise or counterclockwise direction.

The clockwise and the counterclockwise directions are the directions as seen in plan view, and the clockwise direction is an example first curve direction, and the counterclockwise direction is an example second curve direction, which is opposite to the first curve direction. It is also possible to define the clockwise direction as an example second curve direction and the counterclockwise direction as an example first curve direction. It is also possible to enable a direction change in the middle of continuous direction changes.

The moving mechanism 18 can move the discharge part 50 relative to the stage 14 in a curve with a desired radius of curvature. Accordingly, the moving mechanism 18 can move the discharge part 50 relative to the stage 14 in a curve with a first radius of curvature or a second radius of curvature, which is smaller than the first radius of curvature, according to the layer data.

As described above, the moving mechanism 18 relatively moves the discharge part 50 linearly. As a result, the molding material 100 can be molded in a linear shape in the moving direction of the discharge part 50. In addition, as described above, the moving mechanism 18 relatively moves the discharge part 50 in a curve. As a result, the molding material 100 can be molded in a curved shape in the moving direction of the discharge part 50.

The moving mechanism 18 can move the stage 14 also in the height direction of the molding apparatus. As a result of the moving mechanism 18 moving the stage 14 in the height direction of the molding apparatus, the distance between the receiving surface 14A of the stage 14 and the discharge part 50 is adjusted. The moving mechanism 18 may be, for example, a triaxial robot that can move the stage 14 to a desired position in the height, width, and depth directions of the molding apparatus. This allows the stage 14 to rotate or move in a zig-zag manner in accordance with the rotation of the discharge part 50, enabling partial molding in which a shape having no overlapping part, such as a serpentine shape, is formed.

### Molding Unit

The molding unit 12 shown in FIG. 1 is a discharging mechanism that discharges the molding material 100 on the stage 14. The molding unit 12 includes a support body 60, a feeding mechanism 20, a transport unit 40, the discharge part 50, a rotation mechanism 62, a pressure roller 56, a detection sensor 57, an ejecting head 59, and a pressure roller 58.

### Support Body

The support body 60 supports components of the feeding mechanism 20, the transport unit 40, the discharge part 50, etc. The support body 60 supports the discharge part 50 so as to allow rotation about the vertical axis.

### Feeding Mechanism

The feeding mechanism 20 feeds the wire-shaped molding material 100, which is formed of the fiber bundle 110 impregnated with the resin 112. The feeding mechanism 20 includes a feeding part 21, a guide roller 22, and an impregnating unit 24.

### Feeding Part

The feeding part 21 feeds the fiber bundle 110 to the guide roller 22. The feeding part 21 includes a reel around which the fiber bundle 110 is wound. The feeding part 21 is supported by the support body 60 so as to be rotatable.

The feeding part 21 feeds the fiber bundle 110 in the width direction of the molding apparatus (to the left side in FIG. 1) by rotating counterclockwise in FIG. 1.

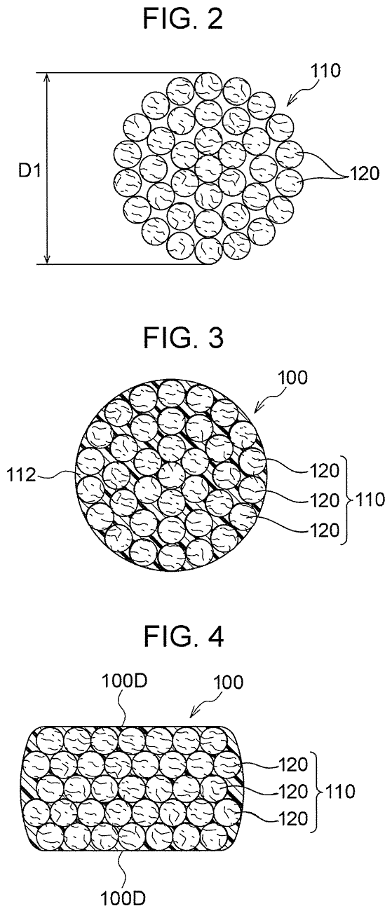

The fiber bundle 110 is a bundle of multiple untwisted continuous fibers 120. In this exemplary embodiment, for example, the continuous fibers 120 are carbon fibers having a diameter of 0.005 mm, and 1000 or more continuous fibers 120 are bundled together into the fiber bundle 110. As shown in FIG. 2, the fiber bundle 110 has a circular cross section having a diameter (Dl in FIG. 2) of 0.3 mm to 0.4 mm. FIG. 2 shows the cross section in which the number of fibers is reduced.

### Guide Roller

As shown in FIG. 1, the guide roller 22 is disposed on one side (the left side in FIG. 1) of the feeding part 21 in the width direction of the molding apparatus and is supported by the support body 60 so as to be rotatable. The guide roller 22 supports the fiber bundle 110 fed out of the feeding part 21.

The fiber bundle 110 fed out of the feeding part 21 in the width direction of the molding apparatus runs on the guide roller 22 and is guided downward. Hence, the guide roller 22 guides the fiber bundle 110 downward.

### Impregnating Unit

The impregnating unit 24 impregnates the fiber bundle 110 with the resin to produce the wire-shaped molding material 100. As shown in FIG. 1, the impregnating unit 24 is disposed downstream of the guide roller 22 in a feed direction in which the molding material 100 is fed from the feeding part 21. More specifically, the impregnating unit 24 is disposed below the guide roller 22.

The impregnating unit 24 includes a passage 26, through which the fiber bundle 110 passes, and a resin supply part 28 that supplies resin to the passage 26.

The resin supply part 28 stores the resin therein. The resin supply part 28 includes a heater 28A for heating the resin stored therein, and a screw 28B for supplying the heated resin to the passage 26. In this exemplary embodiment, for example, the resin stored in the resin supply part 28 is polypropylene resin. The heater 28A heats the stored polypropylene resin to, for example, 180° C. to 300° C. to melt.

The passage 26 allows the fiber bundle 110 fed out of the feeding part 21 to pass therethrough. The passage 26 has a vertically extending cylindrical shape. The passage 26 includes: a receiving port 26A from which the fiber bundle 110 fed out of the feeding part 21 is received; a cylindrical reservoir 26B in which the resin is reserved so as to surround, from the circumferential direction, the fiber bundle 110 passing therethrough; a discharging head 26C from which the molding material 100, which is the fiber bundle 110 impregnated with the resin, is discharged; and a heater 26D attached to the surrounding wall to heat the resin in the reservoir 26B. The receiving port 26A, the reservoir 26B, and the discharging head 26C are arranged in this order from above to below. In this exemplary embodiment, for example, the heater 26D heats the polypropylene resin reserved in the reservoir 26B to 200° C. to 300° C.

In the impregnating unit 24, the resin supply part 28 supplies heated resin to the reservoir 26B of the passage 26. In the passage 26, the fiber bundle 110 entering from the receiving port 26A and passing through the reservoir 26B is impregnated with the resin. The wire-shaped molding material 100, which is the fiber bundle 110 impregnated with the resin, is discharged from the discharging head 26C of the passage 26. As shown in FIG. 3, the spaces between the fibers constituting the molding material 100 discharged from the discharging head 26C are filled with the resin, and the molding material 100 has a circular cross section having a diameter of 0.3 mm to 0.4 mm. FIG. 3 shows the cross section in which the number of fibers is reduced.

Impregnating the fiber bundle 110 with the resin bonds the fibers together. Hence, the impregnating unit 24 serves as a bonding unit that bonds the fibers together.

### Transport Unit

The transport unit 40 transports the molding material 100 supplied from the feeding mechanism 20 to the discharge part 50. As shown in FIG. 1, the transport unit 40 is disposed downstream of the impregnating unit 24 in the feed direction in which the feeding part 21 feeds the molding material 100. The transport unit 40 is disposed below the impregnating unit 24.

The transport unit 40 includes, for example, a pair of transport rollers, 42 and 44. The transport roller 44 is disposed opposite the transport roller 42 with the molding material 100 therebetween.

The transport rollers 42 and 44 are supported by the support body 60 so as to be rotatable. The transport rollers 42 and 44 rotate in the circumferential direction by receiving a driving force from a driving unit (not shown). In the transport unit 40, the rotating transport rollers 42 and 44 transport the molding material 100 nipped therebetween at a speed of, for example, 30 mm/s. The transport speed of the molding material 100 is not limited to 30 mm/s.

The molding material 100 having a circular cross section may be nipped and pressed between the transport rollers 42 and 44 in the transport unit 40 so as to be deformed to have a flat cross section. As shown in FIG. 4, in a flat cross section, the length of the sides extending in one direction is larger than the length of the sides extending in a direction intersecting the one direction, and a pair of planes (hereinbelow “flat planes 100D”) perpendicular to the intersecting direction are formed. In other words, the flat planes 100D are a pair of planes perpendicular to the transverse direction of the flat shape.

The transport rollers 42 and 44 may have a heating portion for heating the molding material 100. The transport unit 40 may have transport belts, instead of the transport rollers.

### Discharge Part

As shown in FIG. 1, the discharge part 50 discharges the molding material 100 on the stage 14. The discharge part 50 is disposed downstream of the transport unit 40 in the feed direction, in which the molding material 100 is fed out from the feeding part 21. The discharge part 50 is disposed below the transport unit 40.

The discharge part 50 has an inflow port 50C through which the molding material 100 transported by the transport unit 40 is introduced, and a discharge port 50B through which the molding material 100 entering from the inflow port 50C is discharged onto the receiving surface 14A of the stage 14. The discharge part 50 may have a heating portion for heating the molding material 100.

### Rotation Mechanism

The rotation mechanism 62 shown in FIG. 1 rotates the discharge part 50. The rotation mechanism 62 rotates the discharge part 50 about the vertical axis. The rotation mechanism 62 positively and negatively rotates the discharge part 50 about the axis perpendicular to the receiving surface 14A of the stage 14.

The rotation mechanism 62 rotates the discharge part 50 to spirally twist the molding material 100 discharged from the discharge part 50. When the discharge part 50 is moved in a curve with respect to the stage 14 to form the molding material 100 in a curved shape, the rotation mechanism 62 rotates the discharge part 50 in the same direction as the direction in which the discharge part 50 is moved in a curve relative to the stage 14 to spirally twist the molding material 100, being formed in a curved shape, as being discharged from the discharge part 50.

More specifically, when the discharge part 50 is moved in the clockwise direction relative to the stage 14, the rotation mechanism 62 positively rotates the discharge part 50 in the clockwise direction, whereas, when the discharge part 50 is moved in the counterclockwise direction relative to the stage 14, the rotation mechanism 62 negatively rotates the discharge part 50 in the counterclockwise direction. The clockwise and the counterclockwise directions are the directions as seen in plan view.

In addition, the rotation mechanism 62 can adjust the number of rotations (rotational number) of the discharge part 50. The number of rotations of the discharge part 50 is the number by which the discharge part 50 rotates per unit time.

In this exemplary embodiment, the rotation mechanism 62 rotates the discharge part 50 by a first rotational number when the discharge part 50 is relatively moved linearly and rotates the discharge part 50 by a second rotational number, which is greater than the first rotational number, when the discharge part 50 is relatively moved in a curve.

More specifically, the rotation mechanism 62 rotates the discharge part 50 by the second rotational number when the discharge part 50 is relatively moved in a curve with the first radius of curvature and rotates the discharge part 50 by a third rotational number, which is greater than the second rotational number, when the discharge part 50 is relatively moved in a curve with the second radius of curvature, which is smaller than the first radius of curvature. The rotation mechanism 62 rotates the discharge part 50 by the second rotational number when the discharge part 50 is relatively moved in a curve with the first radius of curvature or more, and rotates the discharge part 50 by the third rotational number, which is greater than the second rotational number, when the discharge part 50 is relatively moved in a curve with a radius of curvature that is smaller than the first radius of curvature. It is desirable that the rotational number of the discharge part 50 gradually increase as the radius of curvature employed when the discharge part 50 is relatively moved decreases.

### Pressure Roller

The pressure roller 56 shown in FIG. 1 is an example pressure part. The pressure roller 56 presses the molding material 100 discharged from the discharge part 50. The pressure roller 56 applies pressure by pressing the molding material 100 against the receiving surface 14A of the stage 14, thus sandwiching the molding material 100 between the pressure roller 56 and the stage 14. As a result of the pressure roller 56 pressing the molding material 100, variation in height among portions of the molding material 100 discharged on the stage 14 is reduced.

The pressure roller 56 may have a heating portion for heating the molding material 100. The heating portion may be, for example, a heating source provided inside the pressure roller 56. In addition, the heating portion may be a heating device that heats the pressure roller 56 from outside. Examples of the heating source and the heating device include heaters using a heating wire, a halogen lamp, and a laser.

### Detection Sensor

The detection sensor 57 shown in FIG. 1 detects the height of the molding material 100 that has been discharged from the discharge part 50 on the stage 14 and pressed by the pressure roller 56. The detection sensor 57 is disposed downstream of the pressure roller 56 in the discharge direction in which the molding material 100 is discharged. The detection sensor 57 is, for example, a reflection light sensor. For example, the detection sensor 57 emits light onto the molding material 100 discharged from the discharge part 50 on the stage 14 and pressed by the pressure roller 56 and receives the reflected light.

### Discharge Head

The ejecting head 59 shown in FIG. 1 is an example ejecting part. When the difference in height among portions of the molding material 100 discharged from the discharge part 50 on the stage 14 and pressed by the pressure roller 56 is greater than or equal to a predetermined threshold, the ejecting head 59 ejects resin onto the molding material 100. The ejecting head 59 ejects the same type of resin as the resin with which the fiber bundle 110 is impregnated in the impregnating unit 24. The difference in height among portions of the molding material 100 is detected by a detecting unit 17 described below.

### Pressure Roller

The pressure roller 58 shown in FIG. 1 serves as another pressure part that presses the molding material 100 onto which the resin has been discharged from the ejecting head 59. The pressure roller 58 applies pressure to the molding material by pressing the molding material 100 against the receiving surface 14A of the stage 14, sandwiching the molding material 100 between the pressure roller 58 and the stage 14. As a result of the pressure roller 58 applying pressure to the molding material 100, the variation in height among the portions of the molding material 100 is reduced. In addition, gaps and irregularities caused by the difference in spiral state at a linear portion and a curved portion can be minimized.

Similarly to the pressure roller 56, the pressure roller 58 may also have a heating portion for heating the molding material 100. The heating portion may be, for example, a heating source provided inside the pressure roller 58. The heating portion may alternatively be a heating device that heats the pressure roller 58 from outside. Examples of the heating source and the heating device include heaters using a heating wire, a halogen lamp, and a laser.

### Control Unit

The control unit 16 shown in FIG. 1 controls the operations of the respective components of the molding apparatus 10. The control unit 16 includes a read-only memory (ROM) storing a program, a storage unit composed of a storage or the like, and a processor that operates according to the program. The control unit 16 controls the operations of the respective components of the molding apparatus 10 by reading and executing the program stored in the storage unit.

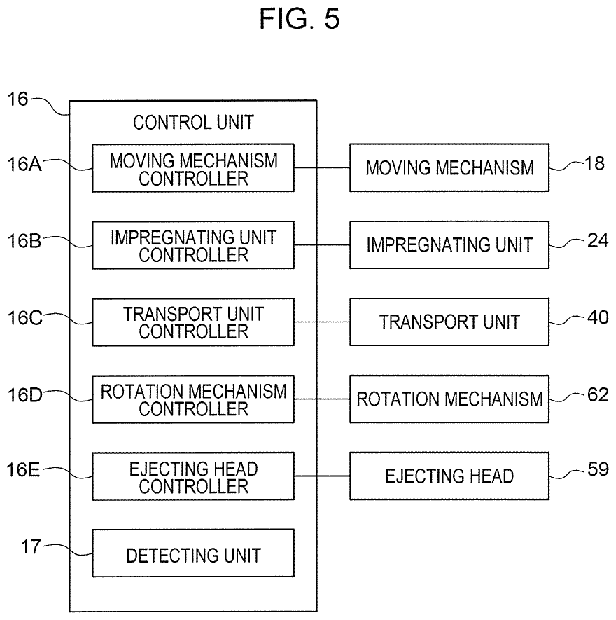

As shown in FIG. 5, the control unit 16 includes, as functional components: the detecting unit 17; a moving mechanism controller 16A that controls the operation of the moving mechanism 18; an impregnating unit controller 16B that controls the operation of the impregnating unit 24; a transport unit controller 16C that controls the operation of the transport unit 40; a rotation mechanism controller 16D that controls the operation of the rotation mechanism 62; and an ejecting head controller 16E that controls the operation of the ejecting head 59. The impregnating unit controller 16B controls the operation of the heater 28A, the screw 28B, and the heater 26D of the impregnating unit 24.

The detecting unit 17 detects the heights of portions of the molding material 100 discharged from the discharge part 50 on the stage 14 and pressed by the pressure roller 56, as well as the difference in height among these portions, on the basis of the detection result obtained by the detection sensor 57. The detecting unit 17 obtains the heights of portions of the molding material 100 on the basis of the reflection time, which is the time elapsed from when the detection sensor 57 emits light to when the detection sensor 57 receives the reflected light. In addition, the detecting unit 17 detects the difference in height among portions from the obtained heights of the portions. More specifically, for example, the difference between the maximum height and the minimum height of the portions within a predetermined area of the molding material 100 is regarded as the difference in height among portions.

The ejecting head controller 16E determines if the difference in height detected by the detecting unit 17 is greater than or equal to a predetermined threshold, and, when it is determined that the difference in height is greater than or equal to the predetermined threshold, causes the ejecting head 59 to discharge resin.

More specifically, the control unit 16 controls the operations of the moving mechanism 18, the feeding mechanism 20, the transport unit 40, the rotation mechanism 62, the ejecting head 59, and the like such that the molding operation described below is performed according to the layer data about multiple layers generated from the three-dimensional data of the article to be molded.

### Molding Operation of Molding Apparatus

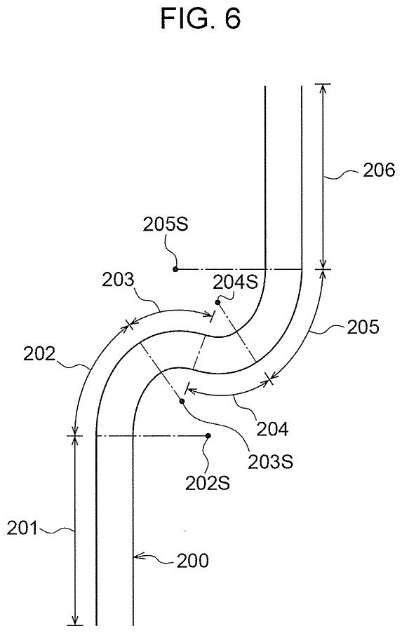

A molding operation of molding an article 200 including a linear portion and a curved portion according to the layer data about multiple layers generated from the three-dimensional data of the article to be molded will be described. More specifically, a molding operation of molding the article 200, which includes linear portions 201 and 206 and curved portions 202, 203, 204, and 205, as shown in FIG. 6, according to the layer data will be described.

The curved portions 202 and 203 are curved in the clockwise direction, whereas the curved portions 204 and 205 are curved in the counterclockwise direction. In other words, the direction in which the spiral is curved in the curved portions 202 and 203 and the direction in which the spiral is curved in the curved portions 204 and 205 are different. Compared with the case where the directions in which the spiral is curved are the same, the twisting of the fibers occurring in changing direction and the residual strain therein are reduced.

In addition, the curved portion 203 has a smaller radius of curvature than the curved portion 202. The curved portion 204 has a smaller radius of curvature than the curved portion 205. The curved portion 202 and the curved portion 205 have the same radius of curvature. The curved portion 203 and the curved portion 204 have the same radius of curvature. In FIG. 6, reference signs 202S, 203S, 204S and 205S denote the centers of curvature of the curved portions 202, 203, 204 and 205.

When the article 200 having the linear portions 201 and 206 and the curved portions 202, 203, 204 and 205 is molded, the moving mechanism 18 moves the stage 14 to move the molding unit 12 including the discharge part 50 relative to the stage 14 in the following manner.

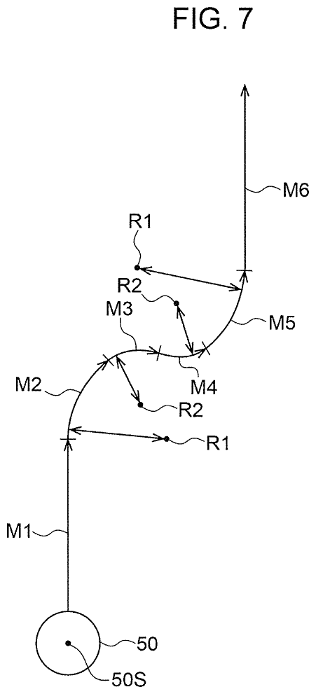

As shown in FIG. 7, first, the discharge part 50 is relatively moved linearly in a first direction M1, (hereinbelow, this movement will be referred to as “linear movement A”). Next, the discharge part 50 is relatively moved in a curve in a clockwise direction M2 with a first radius of curvature R1 (hereinbelow, this movement will be referred to as “curved movement B”). Then, the discharge part 50 is relatively moved in a curve in a clockwise direction M3 with a second radius of curvature R2 (hereinbelow, this movement will be referred to as “curved movement C”). Then, the discharge part 50 is relatively moved in a curve in a counterclockwise direction M4 with the second radius of curvature R2 (hereinbelow, this movement will be referred to as “curved movement D”). Then, the discharge part 50 is relatively moved in a curve in a counterclockwise direction M5 with the first radius of curvature R1 (hereinbelow, this movement will be referred to as “curved movement E”). Then, the discharge part 50 is relatively moved linearly in a second direction M6 (hereinbelow, this movement will be referred to as “linear movement F”). The first direction M1 is, for example, the width direction W of the molding apparatus, as shown in FIG. 1. The clockwise and the counterclockwise directions are the directions as seen in plan view. FIG. 7 shows the locus of the center 50S of the discharge port 50B of the discharge part 50 in plan view.

In this exemplary embodiment, when the molding material 100 is discharged from the discharge part 50, the rotation mechanism 62 rotates the discharge part 50, allowing the molding material 100 to be discharged from the discharge part 50 while being spirally twisted.

More specifically, in the linear movement A, the rotation mechanism 62 rotates the discharge part 50 by a predetermined first rotational number, allowing the molding material 100 to be discharged from the discharge part 50 while being spirally twisted. At this time, the rotation mechanism 62 rotates the discharge part 50 in, for example, the clockwise direction.

Next, in the curved movement B, the rotation mechanism 62 rotates the discharge part 50 in the clockwise direction by the second rotational number, which is greater than the first rotational number, allowing the molding material 100 to be discharged from the discharge part 50 while being spirally twisted.

Next, in the curved movement C, the rotation mechanism 62 rotates the discharge part 50 in the clockwise direction by the third rotational number, which is greater than the second rotational number, allowing the molding material 100 to be discharged from the discharge part 50 while being spirally twisted.

Then, in the curved movement D, the rotation mechanism 62 rotates the discharge part 50 in the counterclockwise direction by the third rotational number, allowing the molding material 100 to be discharged from the discharge part 50 while being spirally twisted.

Then, in the curved movement E, the rotation mechanism 62 rotates the discharge part 50 in the counterclockwise direction by the second rotational number, allowing the molding material 100 to be discharged from the discharge part 50 while being spirally twisted.

Then, in the linear movement F, the rotation mechanism 62 rotates the discharge part 50 by the first rotational number, allowing the molding material 100 to be discharged from the discharge part 50 while being spirally twisted. At this time, the rotation mechanism 62 rotates the discharge part 50 in, for example, the counterclockwise direction.

As shown in FIG. 1, the molding material 100 discharged from the discharge part 50 on the stage 14 is pressed by the pressure roller 56. This reduces variation in height among portions of the molding material 100 discharged on the stage 14.

In addition, in this exemplary embodiment, the detecting unit 17 detects the difference in height among portions of the molding material 100 pressed by the pressure roller 56, on the basis of the detection result obtained by the detection sensor 57.

The ejecting head controller 16E determines whether the difference in height detected by the detecting unit 17 is greater than or equal to the predetermined threshold and, if it is determined that the difference in height is higher than or equal to the predetermined threshold, causes the ejecting head 59 to discharge resin.

The molding material 100 onto which the resin has been discharged from the ejecting head 59 is pressed by the pressure roller 58. This reduces the variation in height among the portions of the molding material 100.

As described above, in this exemplary embodiment, the rotation mechanism 62 rotates the discharge part 50, allowing the molding material 100 to be discharged from the discharge part 50 while being spirally twisted.

Hence, compared with a configuration in which the fiber bundle 110 is spirally twisted and is then impregnated with the resin 112, buckling, breakage, and folding back of the continuous fibers 120 are reduced, and thus, decrease in strength of the molding material 100 is suppressed. In particular, buckling and breakage of the continuous fibers 120 occurring at the curved portions 202, 203, 204 and 205 of the article 200 are reduced, thus suppressing decrease in strength of the molding material 100.

In this exemplary embodiment, when the discharge part 50 is moved in a curve relative to the stage 14 to form a curved shape with the molding material 100, the rotation mechanism 62 rotates the discharge part 50 in the same direction as the direction in which the discharge part 50 is moved in a curve relative to the stage 14, allowing the molding material 100, which is formed in a curved shape, to be discharged from the discharge part 50 while being spirally twisted.

Hence, compared with a configuration in which the rotation mechanism 62 rotates the discharge part 50 in the direction opposite to the direction in which the discharge part 50 is moved in a curve to spirally twist the molding material 100, fracture of the molding material 100 occurring at a curved portion is suppressed.

In this exemplary embodiment, the rotation mechanism 62 positively rotates the discharge part 50 in the clockwise direction when the discharge part 50 is relatively moved in the clockwise direction, and the rotation mechanism 62 negatively rotates the discharge part 50 in the counterclockwise direction when the discharge part 50 is relatively moved in the counterclockwise direction.

Hence, compared with a configuration in which the discharge part 50 is rotated in the same direction regardless of the direction in which the discharge part 50 is moved in a curve, fracture of the molding material 100 at a curved portion is suppressed. In addition, in this configuration, the spiral direction of the molding material 100 is controlled according to the direction in which the discharge part 50 is moved in a curve. Hence, the load applied to the continuous fibers 120 and the internal strain are reduced, thus enabling continuous molding.

In this exemplary embodiment, the rotation mechanism 62 rotates the discharge part 50 by the first rotational number when the discharge part 50 is relatively moved linearly, and rotates the discharge part 50 by the second rotational number, which is greater than the first rotational number, when the discharge part 50 is relatively moved in a curve.

Hence, compared with a configuration in which the rotational number of the discharge part 50 is constant regardless of whether the discharge part 50 is moved linearly or in a curve, fracture of the molding material 100 occurring at a curved portion is suppressed.

In this exemplary embodiment, the rotation mechanism 62 rotates the discharge part by the second rotational number when the discharge part 50 is relatively moved in a curve with the first radius of curvature, and rotates the discharge part 50 by the third rotational number, which is greater than the second rotational number, when the discharge part 50 is relatively moved in a curve with the second radius of curvature.

This configuration reduces fracture of the molding material 100 occurring at a curved portion, compared with a configuration in which the rotational number of the discharge part 50 is constant regardless of the radius of curvature with which the discharge part 50 is relatively moved in a curve.

In this exemplary embodiment, the ejecting head 59 ejects resin onto the molding material 100 when the difference in height among portions of the molding material 100 discharged from the discharge part 50 on the stage 14 is greater than or equal to the predetermined threshold (for example, in the case where the layer thickness is 100 μm, a difference within about 10% of the layer thickness is allowed).

Hence, compared with a configuration in which an article is molded from the molding material 100 in a state of just being discharged on the stage 14, steps (more specifically, for example, steps produced by stacking the continuous fibers 120) between portions of the molding material 100 discharged on the stage 14 are reduced.

In this exemplary embodiment, the pressure roller 56 presses the molding material 100 discharged from the discharge part 50, and, when the difference in height among portions of the molding material 100 pressed by the pressure roller 56 is greater than or equal to the predetermined threshold, resin is discharged onto the molding material 100.

Hence, compared with a configuration in which an article is molded from the molding material 100 in a state of just being discharged on the stage 14, the amount of resin needed to eliminate the steps (more specifically, for example, steps produced by stacking the continuous fibers 120) between portions of the molding material 100 discharged on the stage 14 is reduced.

### Modifications

In this exemplary embodiment, the rotation mechanism 62 rotates the discharge part by the second rotational number when the discharge part 50 is relatively moved in a curve with the first radius of curvature, and rotates the discharge part 50 by the third rotational number, which is greater than the second rotational number, when the discharge part 50 is relatively moved in a curve with the second radius of curvature. However, other configurations are also possible.

For example, the rotation mechanism 62 may rotate the discharge part 50 by the first rotational number when the discharge part 50 is relatively moved in a curve with the first radius of curvature, and may rotate the discharge part 50 by the second rotational number when the discharge part 50 is relatively moved in a curve with the second radius of curvature. In other words, when the discharge part 50 is relatively moved in a curve with the first radius of curvature, the rotation mechanism 62 may rotate the discharge part 50 by the same rotational number as the rotational number employed when the discharge part 50 is relatively moved linearly.

This configuration reduces fracture of the molding material 100 occurring at a curved portion, compared with a configuration in which the rotational number of the discharge part 50 is constant regardless of the radius of curvature employed when the discharge part 50 is relatively moved in a curve.

In this exemplary embodiment, when the discharge part 50 is moved in a curve relative to the stage 14 to allow the molding material 100 to be molded in a curved shape, the rotation mechanism 62 rotates the discharge part 50 in the same direction as the direction in which the discharge part 50 is moved in a curve relative to the stage 14 to spirally twist the molding material 100, to be molded in a curved shape, being discharged from the discharge part 50. However, other configurations are also possible. For example, the rotation mechanism 62 may rotate the discharge part 50 in the direction opposite to the direction in which the discharge part 50 is moved in a curve to spirally twist the molding material 100.

In this exemplary embodiment, the rotation mechanism 62 positively rotates the discharge part 50 in the clockwise direction when the discharge part 50 is relatively moved in the clockwise direction, and the rotation mechanism 62 negatively rotates the discharge part 50 in the counterclockwise direction when the discharge part 50 is relatively moved in the counterclockwise direction. However, other configurations are also possible. For example, the rotation direction of the discharge part 50 may be constant regardless of the direction in which the discharge part 50 is moved in a curve.

In this exemplary embodiment, the rotation mechanism 62 rotates the discharge part 50 by the first rotational number when the discharge part 50 is relatively moved linearly, and rotates the discharge part 50 by the second rotational number, which is greater than the first rotational number, when the discharge part 50 is relatively moved in a curve. However, other configurations are also possible. For example, the rotational number of the discharge part 50 may be constant regardless of whether the discharge part 50 is relatively moved linearly or in a curve.

In this exemplary embodiment, the rotation mechanism 62 rotates the discharge part by the second rotational number when the discharge part 50 is relatively moved in a curve with the first radius of curvature, and rotates the discharge part 50 by the third rotational number, which is greater than the second rotational number, when the discharge part 50 is relatively moved in a curve with the second radius of curvature. However. However, other configurations are also possible. For example, the rotational number of the discharge part 50 may be constant (more specifically, the second rotational number may be employed) regardless of the radius of curvature employed when the discharge part 50 is relatively moved.

In this exemplary embodiment, the ejecting head 59 ejects resin onto the molding material 100 when the difference in height among portions of the molding material 100 discharged from the discharge part 50 on the stage 14 is greater than or equal to the predetermined threshold. However, other configurations are also possible. For example, the ejecting head 59 may be omitted, and the molding material 100 in a state of just being discharged on the stage 14 may be used to mold an article.

In this exemplary embodiment, the ejecting head controller 16E determines whether the difference in height detected by the detecting unit 17 is greater than or equal to a predetermined threshold and, when it is determined that the difference in height is greater than or equal to the predetermined threshold, causes the ejecting head 59 to discharge resin. However, other configurations are also possible. For example, the ejecting head 59 may be caused to eject the resin when the difference in height among portions of the molding material 100 relative to the predetermined reference value (for example, the height of the stage 14) is less than or equal to a predetermined threshold.

The present disclosure is not limited to the above-described exemplary embodiment, and various modifications, changes, improvements are possible within the scope not departing from the spirit thereof. For example, the above-described modifications may be combined with one or more other modifications where appropriate.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A molding apparatus comprising:
a receiving part on which a wire-shaped molding material that is formed of a bundle of continuous fibers impregnated with resin is discharged;
a discharge part that discharges the molding material on the receiving part; and
a rotation mechanism that rotates the discharge part to spirally twist the molding material being discharged from the discharge part.

2. The molding apparatus according to claim 1, further comprising a moving mechanism that allows the discharge part to move in a curve relative to the receiving part to form the molding material in a curved shape,
wherein the rotation mechanism rotates the discharge part in the same direction as the direction in which the discharge part moves in a curve relative to the receiving part to spirally twist the molding material discharged from the discharge part to be formed in a curved shape.

3. The molding apparatus according to claim 2, wherein
the moving mechanism allows the discharge part to move relative to the receiving part in a curve in a first curve direction to form the molding material in a curved shape curved in the first curve direction, and allows the discharge part to move relative to the receiving part in a curve in a second curve direction, which is opposite to the first curve direction, to form the molding material in a curved shape curved in the second curve direction, and
the rotation mechanism positively rotates the discharge part in the same direction as the first curve direction when the discharge part is relatively moved in the first curve direction, and negatively rotates the discharge part in the same direction as the second curve direction when the discharge part is relatively moved in the second curve direction.

4. The molding apparatus according to claim 1, further comprising a moving mechanism that allows the discharge part to move linearly relative to the receiving part to form the molding material in a linear shape, and that allows the discharge part to move in a curve relative to the receiving part to form the molding material in a curved shape,
wherein the rotation mechanism rotates the discharge part by a first rotational number when the discharge part is relatively moved linearly, and rotates the discharge part by a second rotational number, which is greater than the first rotational number, when the discharge part is relatively moved in a curve.

5. The molding apparatus according to claim 2, further comprising a moving mechanism that allows the discharge part to move linearly relative to the receiving part to form the molding material in a linear shape, and that allows the discharge part to move in a curve relative to the receiving part to form the molding material in a curved shape,
wherein the rotation mechanism rotates the discharge part by a first rotational number when the discharge part is relatively moved linearly, and rotates the discharge part by a second rotational number, which is greater than the first rotational number, when the discharge part is relatively moved in a curve.

6. The molding apparatus according to claim 3, further comprising a moving mechanism that allows the discharge part to move linearly relative to the receiving part to form the molding material in a linear shape, and that allows the discharge part to move in a curve relative to the receiving part to form the molding material in a curved shape,
wherein the rotation mechanism rotates the discharge part by a first rotational number when the discharge part is relatively moved linearly, and rotates the discharge part by a second rotational number, which is greater than the first rotational number, when the discharge part is relatively moved in a curve.

7. The molding apparatus according to claim 4, wherein
the moving mechanism allows the discharge part to move relative to the receiving part in a curve with a first radius of curvature to form the molding material in a curved shape, and allows the discharge part to move relative to the receiving part in a curve with a second radius of curvature, which is smaller than the first radius of curvature, to form the molding material in a curved shape, and
the rotation mechanism rotates the discharge part by the second rotational number when the discharge part is relatively moved in a curve with the first radius of curvature, and rotates the discharge part by a third rotational number, which is greater than the second rotational number, when the discharge part is relatively moved in a curve with the second radius of curvature.

8. The molding apparatus according to claim 5, wherein
the moving mechanism allows the discharge part to move relative to the receiving part in a curve with a first radius of curvature to form the molding material in a curved shape, and allows the discharge part to move relative to the receiving part in a curve with a second radius of curvature, which is smaller than the first radius of curvature, to form the molding material in a curved shape, and
the rotation mechanism rotates the discharge part by the second rotational number when the discharge part is relatively moved in a curve with the first radius of curvature, and rotates the discharge part by a third rotational number, which is greater than the second rotational number, when the discharge part is relatively moved in a curve with the second radius of curvature.

9. The molding apparatus according to claim 6, wherein
the moving mechanism allows the discharge part to move relative to the receiving part in a curve with a first radius of curvature to form the molding material in a curved shape, and allows the discharge part to move relative to the receiving part in a curve with a second radius of curvature, which is smaller than the first radius of curvature, to form the molding material in a curved shape, and
the rotation mechanism rotates the discharge part by the second rotational number when the discharge part is relatively moved in a curve with the first radius of curvature, and rotates the discharge part by a third rotational number, which is greater than the second rotational number, when the discharge part is relatively moved in a curve with the second radius of curvature.

10. The molding apparatus according to claim 1, further comprising a moving mechanism that allows the discharge part to move in a curve with the first radius of curvature relative to the receiving part to form the molding material in a curved shape, and that allows the discharge part to move in a curve with the second radius of curvature, which is smaller than the first radius of curvature, relative to the receiving part to form the molding material in a curved shape, wherein
the rotation mechanism rotates the discharge part by the first rotational number when the discharge part is relatively moved in a curve with the first radius of curvature, and rotates the discharge part by a second rotational number, which is greater than the first rotational number, when the discharge part is relatively moved in a curve with the second radius of curvature.

11. The molding apparatus according to claim 2, further comprising a moving mechanism that allows the discharge part to move in a curve with the first radius of curvature relative to the receiving part to form the molding material in a curved shape, and that allows the discharge part to move in a curve with the second radius of curvature, which is smaller than the first radius of curvature, relative to the receiving part to form the molding material in a curved shape, wherein
the rotation mechanism rotates the discharge part by the first rotational number when the discharge part is relatively moved in a curve with the first radius of curvature, and rotates the discharge part by a second rotational number, which is greater than the first rotational number, when the discharge part is relatively moved in a curve with the second radius of curvature.

12. The molding apparatus according to claim 3, further comprising a moving mechanism that allows the discharge part to move in a curve with the first radius of curvature relative to the receiving part to form the molding material in a curved shape, and that allows the discharge part to move in a curve with the second radius of curvature, which is smaller than the first radius of curvature, relative to the receiving part to form the molding material in a curved shape, wherein
the rotation mechanism rotates the discharge part by the first rotational number when the discharge part is relatively moved in a curve with the first radius of curvature, and rotates the discharge part by a second rotational number, which is greater than the first rotational number, when the discharge part is relatively moved in a curve with the second radius of curvature.

13. The molding apparatus according to claim 1, further comprising:
a detecting unit that detects the height of the molding material discharged from the discharge part on the receiving part; and
an ejecting part that ejects resin onto the molding material when the difference in height among portions of the molding material is greater than or equal to a predetermined threshold.

14. The molding apparatus according to claim 13, further comprising a pressure part that presses the molding material discharged from the discharge part on the receiving part, wherein the detecting unit detects the height of the molding material pressed by the pressure part.
